(19) United States
(12) Patent Application Publication
(10) Pub. No.: US 2004/0249948 A1
(43) Pub. Date: Dec. 9, 2004

(54) Performing application layer transactions during the connection establishment phase of connection-oriented protocols

(76) Inventors: Bhupinder S. Sethi, Redmond, WA (US); Michael R. Fortin, Redmond, WA (US); Art Shelest, Sammamish, WA (US)

Correspondence Address: RICK D. NYDEGGER, WORKMAN, NYDEGGER & SEELEY, 1000 Eagle Gate Tower, 60 East South Temple, Salt Lake City, UT, 84111, US

(21) Appl. No.: 10/384,465

(22) Filed: Mar. 7, 2003

(51) Int. Cl. G06F 15/16

(52) U.S. Cl. 709/227

(57) ABSTRACT

When a client issues a network transaction like HTTP requests to a server, such requests may require a connection to be established between the client and the server over a reliable transport like TCP (if no such connection is available). Such connection establishment takes time, and delays the completion of the transaction, thereby degrading user experience. This invention attempts to reduce this delay by transparently executing idempotent transactions in parallel with the connection establishment phase. In case the end hosts do not support the functionality of this invention, said functionality can be transparently added through software components between the client and server. Client and server side intermediate components simulate connection establishment making it appear to corresponding application layers that a connection is established. Accordingly, the application layers respond with application layer requests or responses when in fact no connection has yet been established to transmit the requests or responses.

### BACKGROUND OF THE INVENTION

1. The Field of the Invention

The present invention relates to network communication technology, and more specifically, to mechanisms for performing application layer transactions during the connection establishment phase of connection-oriented protocols.

2. Background and Relevant Art

Computer networks have enhanced our ability to communicate and access information by allowing one computer or device (hereinafter both referred to as a “computing system”) to communicate over a network with another computing system using electronic messages. When transferring an electronic message between computing systems, the electronic message will often pass through a protocol stack that performs operations on the data within the electronic message (e.g., packetizing, routing, flow control). The Open System Interconnect (“OSI”) model is an example of a networking framework for implementing a protocol stack.

The OSI model breaks down the operations for transferring an electronic message into seven distinct “layers,” each designated to perform certain operations in the data transfer process. While protocol stacks can potentially implement each of the layers, many protocol stacks implement only selective layers for use in transferring data across a network. When data is transmitted from a computing system, it originates at the application layer and is passed down to intermediate lower layers and then onto a network. When data is received from a network it enters the physical layer and is passed up to higher intermediate layers and then eventually received at the application layer.

The application layer, the upper most layer, is responsible for supporting applications and end-user processes. Another layer incorporated by most protocol stacks is the transport layer, which can provide the features of end-to-end error recovery, resequencing, and flow control to the application layer. An example of a transport layer protocol that implements these features is the Transmission Control Protocol (“TCP”).

In many network environments, a client application at a client computing system (hereinafter referred to as a “client”) will request access to a resource of a server application at a server computing system (hereinafter referred to as a “server”). If an appropriate request is received by the server application, the server application can then respond by sending the requested resource to the client application. For example, in an Internet environment, a Web browser at the client may request access to a Web page managed by a Web server at the server. To request access to the Web page, the Web browser will typically generate an appropriate HyperText Transfer Protocol (“HTTP”) GET command (e.g., including the Uniform Resource Locator (“URL”) of the Web page) that is then transferred to the Web server. When the Web server receives the HTTP GET command, the Web server can respond by sending an HTTP message that includes the requested Web page back to the Web browser.

Generally, it is desirable for HTTP data (e.g., HTTP commands and HTTP messages) to be reliably transferred, such as, for example, by utilizing end-to-end error recovery, resequencing, and flow control. Unfortunately, HTTP is a stateless protocol and does not inherently include support for reliable transfer of HTTP data. As such, the features of TCP are often utilized to increase reliability when transferring HTTP data. However, TCP is a connection-oriented protocol and thus requires the establishment of a TCP connection between the client and the server before the features of TCP can be realized. Accordingly, a TCP connection is typically established between the client and the server before any HTTP data is transferred.

Establishment of a TCP connection is performed by exchanging a number of TCP packets (often referred to as TCP segments), in what is typically referred to as a three-way handshake. To initiate a three-way handshake, the client sends a SYN (synchronize) packet to the server (e.g., by sending the SYN packet to an Internet Protocol (“IP”) address associated with the server). The client can indicate that a TCP packet is a SYN packet by setting an appropriate SYN control bit in a corresponding TCP packet header. The SYN packet can also include a client initial sequence number that identifies the sequence number of first byte of data that will be sent by the client. For example, a client may send a SYN packet including a client initial sequence number of 100 to identify that the first byte sent from the client will be byte 100.

After receiving the SYN packet, the server can respond by sending a SYN-ACK (synchronize-acknowledgment) packet back to the client (e.g., by sending the SYN-ACK packet to an IP address associated with the server). The server can indicate that a TCP packet is a SYN-ACK packet by setting an appropriate SYN control bit and an appropriate ACK control bit in a corresponding TCP header. The SYN-ACK packet can also include a server initial sequence number and an updated client sequence number. The updated client sequence number identifies the next byte that should be received from the client. Appropriately updating an initial sequence number typically includes incrementing the initial sequence number by one since SYN packets are considered one-byte in length. For example, the server may send a SYN-ACK packet with a server initial sequence number of 300 to identify that the first byte sent from the server will be byte 300 and an updated client sequence number of 101 to identify that the next byte received from the client should be byte 101.

After receiving the SYN-ACK packet, the client can respond by sending an ACK (acknowledgment) packet back to the server. The client can indicate that a TCP packet is an ACK packet by setting an appropriate ACK control bit in a corresponding TCP header. The ACK packet can also include an updated server sequence number that identifies the next byte that should be received from the server. For example, the client may send an ACK packet with an updated server sequence number of 301 to identify that the next byte received from the server should be byte 301.

Also after receiving the SYN-ACK packet, the client determines if the updated client sequence number is an appropriate acknowledgment of the client initial sequence number. For example, if a one byte SYN packet was sent with a client initial sequence number of 100, a received SYN-ACK packet should include an appropriately updated client sequence number of 101 indicating that the next byte received from the client will be byte 101. When the updated client sequence number is appropriate, the client views a TCP connection as being established from the client to the server. Accordingly, the client may also include HTTP data (e.g., an HTTP GET command) in the ACK packet. Thus, at least two TCP packets (the SYN packet and the SYN-ACK packet) must be successfully transferred before any HTTP data can be sent from the client to the server.

After receiving the ACK packet, the server can determine if the updated server sequence number is an appropriate acknowledgement of the server initial sequence number. When the updated server sequence number is appropriate, the server views a TCP connection as being established from the server to the client. Accordingly, the server may send HTTP data (e.g., an HTTP message including a Web page) to the client. Thus, at least three TCP packets (the SYN packet, the SYN-ACK, and the ACK packet) must be successfully transferred before any HTTP data can be sent from the server to the client.

As such, presentation of a Web page at a client will typically be delayed by at least the amount of time required to successfully transfer four TCP packets (the SYN packet, the SYN-ACK, the ACK packet, and a TCP packet including a Web page). When a TCP packet is transferred across a network that is experiencing increased latency (e.g., a wireless network), the time required to successfully transfer the TCP packet can substantially increase. Thus, the elapsed time between originating an HTTP GET command and presentation of a corresponding Web page (the time for transferring four TCP packets) may also substantially increase. This can degrade a user's Web browsing experience.

Further, as is often the case on the Internet, a single HTTP GET command can trigger a number of Web downloads. It may be that an HTTP GET command including a first URL is sent to a Web server to request a Web page. Embedded within the Web page may be a number of other URLs referencing auxiliary resources (e.g., images, advertisements, etc.) at other locations. To appropriately present the Web page, the Web browser may be required to download and present these auxiliary resources. Accordingly, the client may establish a TCP connection to each location that includes one or more of the auxiliary resources. Delay in receiving one or more of the auxiliary resources can temporarily result in incomplete (or even incomprehensible) presentation of the Web page thereby further degrading the user's Web browsing experience.

Therefore systems, methods, and computer program products for more efficiently completing application layer transactions would be advantageous.

### BRIEF SUMMARY OF THE INVENTION

The foregoing problems with the prior state of the art are overcome by the principles of the present invention, which are directed towards methods, systems, and computer program products for performing application layer transactions during the connection establishment phase of connection-oriented protocols. A client side application (e.g., a Web browser) at a client computer system (hereinafter referred to as a “client”) generates an application layer request (e.g., an HTTP GET command generated in response to receiving user input) that is to be sent across a computer network to a server computer system having a corresponding server side application (e.g., a Web server). A client side connection-oriented protocol layer, such as, for example, a client side Transmission Control Protocol (“TCP”) layer, receives the application layer request.

In response to receiving the application layer request, the client side connection-oriented protocol layer sends first client side connection establishment data (e.g., a client side SYN packet) that is to be delivered to a corresponding server side connection-oriented protocol layer at a server computer system (hereinafter referred to as a “server”). The first client side connection establishment data can be connection establishment data for initiating the establishment of a connection (e.g., a TCP connection) between the client and the server. A client side intermediate component, such as, for example, a client side intermediate driver or a client side intermediate computer system, receives the first client side connection establishment data and prevents the first client side connection establishment data from being delivered to the computer network (thereby also preventing delivery to the server).

The client side intermediate component sends second client side connection establishment data (e.g., a client side SYN-ACK packet), which would normally be returned by the server in response to receiving the first client side connection establishment data, to the client side connection-oriented protocol layer. Thus, it appears to the client side connection-oriented protocol layer that the server appropriately acknowledged the first client side connection establishment data. Accordingly, the client side connection-oriented protocol layer views a connection as having been established from the client to the server (when in fact no connection has been established) and sends third client side connection establishment data along with the application layer request. The client side intermediate component receives the third client side connection establishment data (e.g., a client side ACK packet) and the application layer request from the client side connection-oriented protocol layer.

The client side intermediate component then sends first network connection establishment data (e.g., a network SYN packet) along with the application layer request to the computer network for delivery to the server computer system. A server side intermediate component, such as, for example, a server side intermediate driver or a server side intermediate computer system, receives the first network connection establishment data and the application layer request. The server side intermediate component separates the application layer request from the first network connection establishment data and sends the first network establishment data to the server side connection-oriented protocol layer. In response, the server side connection-oriented protocol layer sends first server side connection establishment data (e.g., a server side SYN-ACK packet).

The server side intermediate component receives the first server side connection establishment data and prevents the first server side connection establishment data from being delivered to the computer network (thereby also preventing delivery to the client). The server side intermediate component sends second server side connection establishment data (e.g., a server side ACK packet), which would normally be returned by the client in response to receiving the first server side connection establishment data, along with the application layer request to the server side connection-oriented protocol layer. Accordingly, the server side connection-oriented protocol layer views a connection as being established from the server to the client (when in fact no connection has been established) and transfers the application layer request to the server side application.

In response to receiving the application layer request, the server side application sends a corresponding application layer response, which is transferred from the server side application, through the server side connection-oriented protocol layer, for delivery to the client. The server side intermediate component receives the application layer response (e.g., a Web page). The server side intermediate component sends second network connection establishment data (e.g., a network SYN-ACK packet) corresponding to the first network connection establishment data (e.g., corresponding to the network SYN packet) along with the application layer response to the client. The client side intermediate component receives the second network connection establishment data and the application layer response. The client side intermediate component sends the application layer response to the client side application. The client side application can then present the application layer response to a user at the client.

Thus, the principles of the present provide for completing an application layer transaction without having to wait for a connection to be established between a client and a server. The application layer transaction can be completed with increased efficiency since the number of round-trips over a network (e.g., over the Internet) utilized to complete the application layer transaction is potentially reduced.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a suitable operating environment for the principles of the present invention.

FIG. 2 illustrates a first example of a network architecture that facilitates the performance of an application layer transaction during the connection establishment phase of a connection-oriented protocol.

FIG. 3 illustrates an example flowchart of a method for performing an application layer transaction during the connection establishment phase of a connection-oriented protocol.

FIG. 4 illustrates a second example of a network architecture that facilitates the performance of an application layer transaction during the connection establishment phase of a connection-oriented protocol.

### DETAILED DESCRIPTION OF THE PREFERRED EMBODIMENTS

The principles of the present invention provide for performing application layer transactions during the connection establishment phase of connection-oriented protocols. A client computer system (hereinafter referred to as the “client”) and a server computer system (hereinafter referred to as a “server”) are connected to a computer network (e.g., the Internet). A client side application at the client generates an application layer request that is to be serviced by a corresponding server side application at the server. Accordingly, a client side connection oriented-protocol layer sends first client side connection establishment data (e.g., a client side SYN packet) that is to be delivered to the server in order to establish a connection between the client and the server.

However, a client side intermediate component (e.g., a client side intermediate driver or client side intermediate computer system) prevents the first client side connection establishment data from being delivered. The client side intermediate component sends second client side connection establishment data (e.g., a client side SYN-ACK packet), which would normally be returned by the server in response to the server receiving the first client side connection establishment data, to the client side connection-oriented protocol layer. As such, it appears to the client side connection-oriented protocol layer that the server responded to the first server connection establishment data and that a connection has been established from the client to the server. Accordingly, the client side connection-oriented protocol layer sends third client side connection establishment data (e.g., a client side ACK packet) along with the application layer request that are to be delivered to the server.

The client side intermediate component receives the third client side connection establishment data and the application layer request. The client side intermediate component then sends first network connection establishment data (e.g., a network SYN packet) along with the application layer request to the server. A server side intermediate component receives the first network connection establishment data and the application layer request. The server side intermediate component separates the application layer request from the first network connection establishment data and sends the first network connection establishment data to the server side connection-oriented protocol layer.

Accordingly, the server side connection-oriented protocol layer responds by sending first server side connection establishment data (e.g., a server side SYN-ACK) that is to be delivered to the client. The server side intermediate component receives the first server side connection establishment data and prevents the first server side connection establishment data from being delivered. The server side intermediate component sends second server side connection establishment data (e.g., a server side ACK packet), which would normally be returned by the client in response to receiving the first server side connection establishment data, along with the application layer request to the server side connection-oriented protocol layer. As such, it appears to the server side connection-oriented protocol layer that the client has responded to the first side server connection establishment data and that a connection has been established from the server to the client.

Accordingly, the server side connection-oriented protocol layer forwards the application layer request to the server side application. In response to receiving the application layer request, the server side application generates an application layer response that is transferred through the server side connection-oriented protocol layer for delivery to the client. The server side intermediate component receives the application layer response. The server side intermediate component sends second network connection establishment data (e.g., a network SYN-ACK) corresponding to the first network connection establishment data along with the application layer response to the client. The client side intermediate component receives the second network connection establishment data and the application layer response. The client side intermediate component forwards only the application layer response to the client application.

Embodiments within the scope of the present invention include computer-readable media for carrying or having computer-executable instructions or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

When information is transferred or provided over a network or another communications connection (either hardwired, wireless, or a combination of hardwired or wireless) to a computer system, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions. The computer executable instructions may C be, for example, binaries, intermediate format instructions such as assembly language, or even source code.

In this description and in the following claims, a “computer system” is defined as one or more software modules, one or more hardware modules, or combinations thereof, that work together to perform operations on electronic data. For example, the definition of computer system includes the hardware components of a personal computer, as well as software modules, such as the operating system of the personal computer. The physical layout of the modules is not important. A computer system may include one or more computers coupled via a network. Likewise, a computer system may include a single physical device (such as a mobile phone or Personal Digital Assistant “PDA”) where internal modules (such as a memory and processor) work together to perform operations on electronic data.

In this description and in the following claims, “client” is defined as a computer system that accesses (or attempts to access) a service provided by another computer system. In this description and in the following claims, “server” is defined as a computer system that provides a service that can be accessed by other computer systems. Depending on the environment, a computer system may access services from other computer systems and/or provide services to other computer systems. Thus, a computer system may act as a client in one context and a server in another context.

In this description and in the following claims, “data element” is defined generally as a grouping of electronic data, such as, for example, a data frame, a data segment, a data packet, a datagram, a message, or a SOAP envelope, that is transferred between modules and/or components of a computer system or transferred between modules and/or components of different computer systems. Data element is defined to include header portions and/or body portions of a grouping of electronic data.

In this description and in the following claims, a “logical communication link” is defined as any communication path that enables the transport of electronic data between computer systems and/or modules. The actual physical representation of a communication path between is not important and may change over time, such as, for example, when the routing path of a packet is changed. A logical communication link may include portions of a system bus, a local area network (“LAN”), a wide area network (“WAN”), the Internet, combinations thereof, or portions of any other path that facilitates the transport of electronic data. Logical communication links are defined to include hardwired links, wireless links, or a combination of hardwired links and wireless links. Logical communication links can also include software or hardware modules that condition or format portions of data so as to make the portions of data accessible to components that implement the principles of the present invention (e.g., proxies, routers, gateways, etc).

In this description and in the following claims, an “idempotent” transaction is defined as a transaction that has essentially the same effect on a server no matter how many times the idempotent transaction is executed. For example, whether an idempotent transaction is executed once, twice, or even five times, the resulting effect on the server would be essentially the same. Transactions resulting from a client's issuance of HyperText Transfer Protocol (“HTTP”) GET and HEAD commands are examples of idempotent transactions.

Those skilled in the art will appreciate that the invention may be practiced in network computing environments with many types of computer system configurations, including, personal computers, laptop computers, hand-held devices, multi-processor systems, microprocessor-based or programmable consumer electronics, network PCs, minicomputers, mainframe computers, mobile telephones, PDAs, pagers, routers, gateways, proxies, and the like. The invention may also be practiced in distributed system environments where local and remote computer systems, which are linked (either by hardwired links, wireless links, or by a combination of hardwired and wireless links) through a network, both perform tasks. In a distributed system environment, program modules may be located in both local and remote memory storage devices.

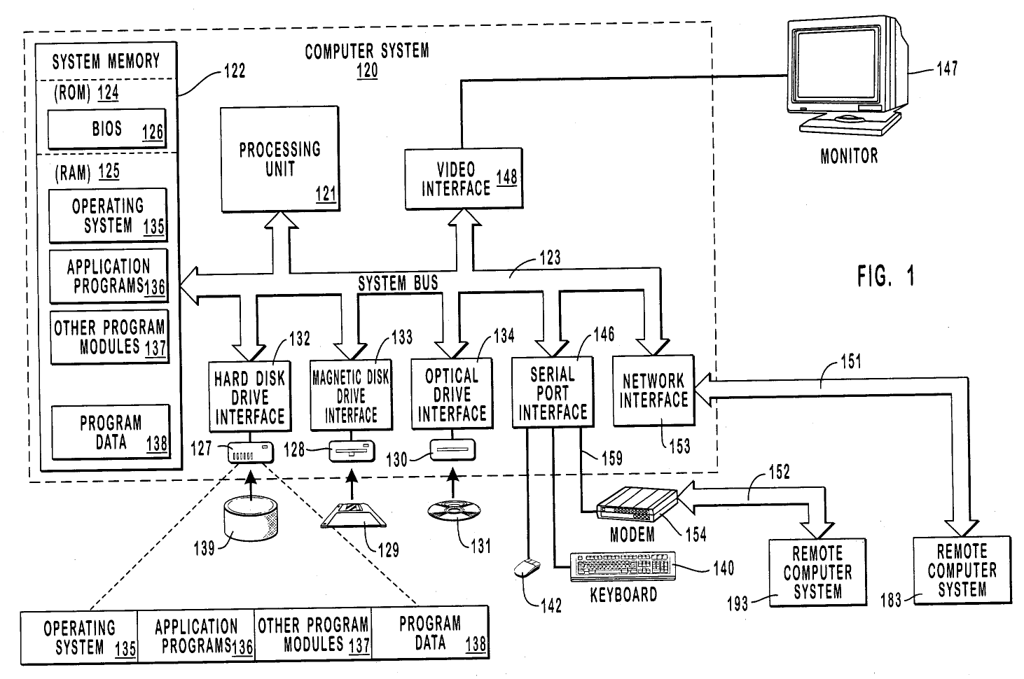

FIG. 1 and the following discussion are intended to provide a brief, general description of a suitable computing environment in which the invention may be implemented. Although not required, the invention will be described in the general context of computer-executable instructions, such as program modules, being executed by computer systems. Generally, program modules include routines, programs, objects, components, data structures, and the like, which perform particular tasks or implement particular abstract data types. Computer-executable instructions, associated data structures, and program modules represent examples of the program code means for executing acts of the methods disclosed herein.

With reference to FIG. 1, an example system for implementing the invention includes a general-purpose computing device in the form of computer system 120, including a processing unit 121, a system memory 122, and a system bus 123 that couples various system components including the system memory 122 to the processing unit 121. Processing unit 121 can execute computer-executable instructions designed to implement features of computer system 120, including features of the present invention. The system bus 123 may be any of several types of bus structures including a memory bus or memory controller, a peripheral bus, and a local bus using any of a variety of bus architectures. The system memory includes read only memory (“ROM”) 124 and random access memory (“RAM”) 125. A basic input/output system (“BIOS”) 126, containing the basic routines that help transfer information between elements within the computer 120, such as during start-up, may be stored in ROM 124.

The computer system 120 may also include a magnetic hard disk drive 127 for reading from and writing to a magnetic hard disk 139, a magnetic disk drive 128 for reading from or writing to a removable magnetic disk 129, and an optical disk drive 130 for reading from or writing to removable optical disk 131, such as, or example, a CD-ROM or other optical media. The magnetic hard disk drive 127, magnetic disk drive 128, and optical disk drive 130 are connected to the system bus 123 by hard disk drive interface 132, magnetic disk drive-interface 133, and optical drive interface 134, respectively. The drives and their associated computer-readable media provide nonvolatile storage of computer-executable instructions, data structures, program modules, and other data for the computer system 120. Although the example environment described herein employs a magnetic hard disk 139, a removable magnetic disk 129 and a removable optical disk 131, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 139, magnetic disk 129, optical disk 131, ROM 124 or RAM 125, including an operating system 135, one or more application programs 136, other program modules 137, and program data 138. A user may enter commands and information into the computer system 120 through keyboard 140, pointing device 142, or other input devices (not shown), such as, for example, a microphone, joy stick, game pad, scanner, or the like. These and other input devices can be connected to the processing unit 121 through serial port interface 146 coupled to system bus 123. Alternatively, input devices can be connected by other interfaces, such as, for example, a parallel port, a game port, a universal serial bus (“USB”) port, or a Fire Wire port. A monitor 147 or other display device is also connected to system bus 123 via video interface 148. Computer system 120 can also be connected to other peripheral output devices (not shown), such as, for example, speakers and printers.

Computer system 120 is connectable to networks, such as, for example, an office-wide or enterprise-wide computer network, an intranet, and/or the Internet. Computer system 120 can exchange data with external sources, such as, for example, remote computer systems, remote applications, and/or remote databases over such a network.

Computer system 120 includes network interface 153, through which computer system 120 receives data from external sources and/or transmits data to external sources. As depicted in FIG. 1, network interface 153 facilitates the exchange of data with remote computer system 183 via logical communication link 151. Logical communication link 151 represents a portion of a network, and remote computer system 183 represents a node of the network. For example, remote computer system 183 may be a server computer system that services requests from computer system 120 and responds to the requests by returning resources to computer system 120. On the other hand, remote computer system 183 may be a client computer system that requests resources from computer system 120 and receives resources that are sent by computer system 120 in response to the requests.

Likewise, computer system 120 includes serial port interface 146, through which computer system 120 receives data from external sources and/or transmits data to external sources. Serial port interface 146 is coupled to modem 154 via logical communication link 159, through which computer system 120 receives data from and/or transmits data to external sources. As depicted in FIG. 1, serial port interface 146 and modem 154 facilitate the exchange of data with remote computer system 193 via logical communication link 152. Logical communication link 152 represents a portion of a network, and remote computer system 193 represents a node of the network. For example, remote computer system 193 may be a server computer system that services requests from computer system 120 and responds to the requests by returning resources to computer system 120. On the other hand, remote computer system 193 may be a client computer system that requests resources from computer system 120 and receives resources that are sent by computer system 120 in response to the requests.

While FIG. 1 represents a suitable operating environment for the present invention, the principles of the present invention may be employed in any system that is capable of, with suitable modification if necessary, implementing the principles of the present invention. The environment illustrated in FIG. 1 is illustrative only and by no means represents even a small portion of the wide variety of environments in which the principles of the present invention may be implemented.

In accordance with the present invention, applications, application layers, connection-oriented protocol layers, intermediate components, and network interface modules as well as associated data, including connection establishment data, application layer requests, application layer responses, and data elements may be stored and accessed from any of the computer-readable media associated with computer system 120. For example, portions of such modules and portions of associated program data may be included in operating system 135, application programs 136, program modules 137 and/or program data 138, for storage in system memory 122.

When a mass storage device, such as, for example, magnetic hard disk 139, is coupled to computer system 120, such modules and associated program data may also be stored in the mass storage device. In a networked environment, program modules depicted relative to computer system 120, or portions thereof, can be stored in remote memory storage devices, such as, for example, system memory and/or mass storage devices associated with remote computer system 183 and/or remote computer system 193. Execution of such modules may be performed in a distributed environment as previously described.

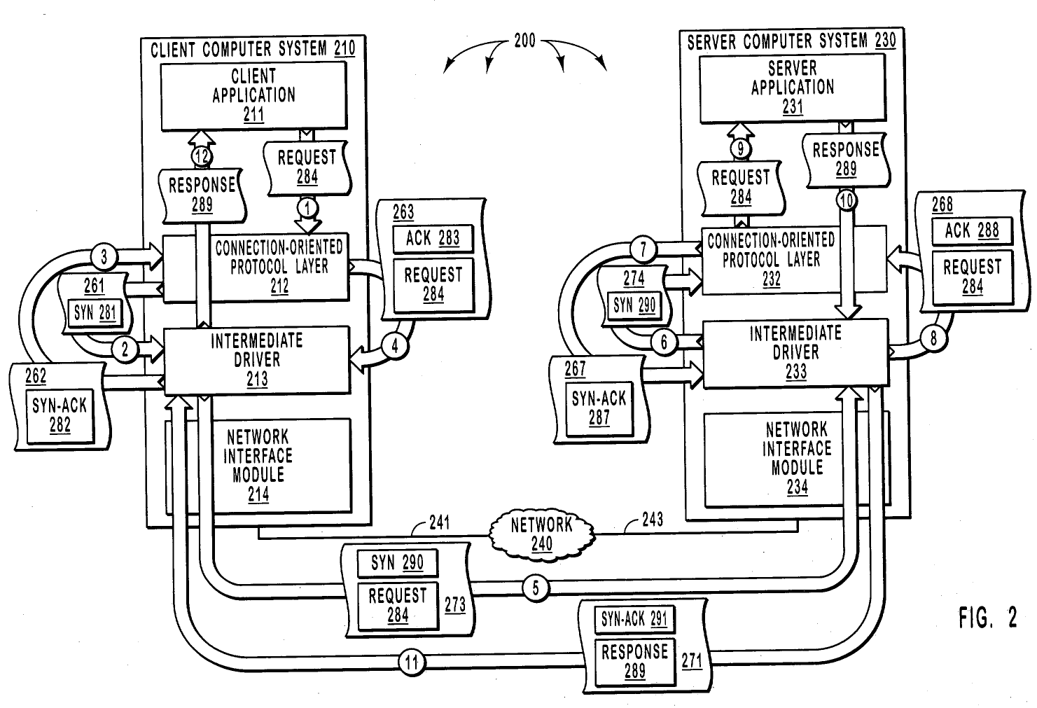

FIG. 2 illustrates a first example of network architecture 200 that can facilitate performing an application layer transaction during the connection establishment phase of a connection-oriented protocol. Included in network architecture 200 are client computer system 210 and server computer system 230. Client computer system 210 and server computer system 230 are connected to network 240 via corresponding logical communication links 241 and 243 respectively. Network 240 can be any type of computer network, such as, for example, a LAN, a WAN, or even the Internet, and can include wireless and/or wired network infrastructures.

Client application 211 can generally be any application (e.g., a Web browser, an electronic mail client, file system, etc.) that is configured to send application layer requests and receive application layer responses. An application layer request and application layer response may be part of an idempotent transaction between a client and a server. Application layer requests can include commands of virtually any application layer protocol, such as, for example, HTTP GET commands, HTTP HEAD commands, Post Office Protocol (“POP”) retr commands, File Transfer Protocol (“FTP”) get and mget commands, Internet Message Access Protocol (“IMAP”) fetch commands, and Domain Name Service (“DNS”) queries. Application layer responses can include resources of virtually any type, such as, for example, Web pages, electronic mail messages, files, Uniform Resource Identifiers (“URIs”), and/or address resources.

It may be that an application layer request is generated in response to user-input received at a user-input device, such as, for example, pointing device 142 or keyboard 140. A client side connection-oriented protocol layer can receive application layer requests that are to be delivered to a server computer system. For example, as illustrated by arrow 1 in FIG. 2, connection-oriented protocol layer 212 receives application layer request 284 (hereinafter referred to as “request 284”) from client application 211. A connection-oriented protocol layer can be a layer for virtually any connection-oriented protocol, such as, for example, a Transmission Control Protocol (“TCP”) layer, a Sequenced Packet Exchange (“SPX”) layer, an AppleTalk Data Streaming Protocol (“ADSP”) layer, or a NetBIOS layer.

In response to receiving request 284, connection-oriented protocol layer 212 may attempt to establish a connection with a corresponding server side connection-oriented protocol layer, such as, for example, connection-oriented protocol layer 232. This can include connection oriented protocol layer 212 attempting to transfer connection establishment data, such as, for example, data elements of a three-way handshake, to facilitate establishment of a connection over which request 284 can subsequently be sent and application layer responses received.

On the other hand, server application 231 can generally be any application (e.g., a Web server, an electronic mail server, a file server, etc.) that is configured to receive application layer requests from requesting client computer systems and respond by returning application layer responses to the requesting client computer systems. Before an application layer request is received, connection-oriented protocol layer 232 may attempt to participate in the establishment of a connection with a corresponding client side connection-oriented protocol layer, such as, for example, connection-oriented protocol layer 212. This can include connection-oriented protocol layer 232 attempting to transfer connection establishment data, such as, for example, data elements of a three-way handshake, to facilitate establishment of a connection. After a connection is established, connection oriented-protocol layer 232 can receive application layer requests (e.g., request 284). Accordingly, in response to receiving an application layer request, server application 231 can send an application layer response, such as, for example, application layer response 289 (hereinafter referred to as “response 289”), that is to be delivered to a requesting client computer system.

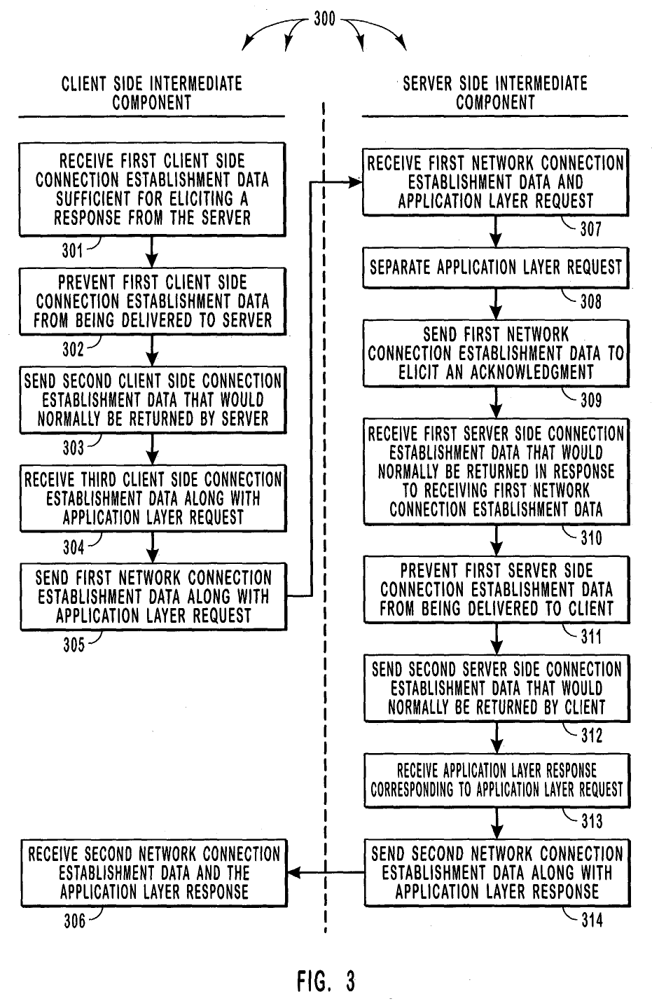

FIG. 3 illustrates an example flowchart of a method 300 for performing an application layer transaction during the connection establishment phase of a connection-oriented protocol. The method 300 will be described with respect to the computer systems depicted in network architecture 200.

Method 300 includes an act of receiving first client side connection establishment data sufficient for eliciting a response from a server (act 301). Act 301 can include a client side intermediate component receiving first client side connection establishment data from a client side connection-oriented protocol layer. A client side intermediate component can be situated in a data path between a client side network interface module and the client side connection oriented-protocol layer. As such, data elements being delivered between the client side network interface module and the client side connection oriented-protocol layer can be received by the client side intermediate component. For example, as illustrated by arrow 2 in FIG. 2, intermediate driver 213 receives data element 261, which includes SYN 281, from connection-oriented protocol layer 212. Connection-oriented protocol layer 212 may have generated data element 261 in response to receiving request 284 (e.g., a request portion of an idempotent transaction) from client application 211. Connection-oriented protocol layer 212 can indicate SYN 281 by setting the appropriate SYN control bit within data element 261.

Data element 261 may be first client side connection establishment data of a three-way handshake that is to be used to establish a connection between connection-oriented protocol layer 212 and connection-oriented protocol layer 232. Thus, data element 261 may be sufficient to elicit a data element from connection-oriented protocol layer 232 if received by connection connection-oriented protocol layer 232. Data element 261 may also include an initial client side sequence number identifying the next byte that will be sent by client computer system 210.

Method 300 includes an act of preventing first client side connection establishment data from being delivered to the server (act 302). Act 302 can include the client side intermediate component preventing first client side connection establishment data from being delivered to the server computer system. For example in FIG. 2, intermediate driver 213 can prevent SYN 281 (as well as any other connection-establishment data included in data element 261) from being delivered to server computer system 230.

In some embodiments, intermediate driver 213 checks data element 261 to detect the communications options that connection-oriented protocol layer 212 is attempting to utilize. When specified options, such as, for example, a window scaling option, are detected, intermediate driver 213 allows data element 261 pass through to network interface module 214. On the other hand, when specified options are not detected, intermediate driver 213 prevents data element 261 from being delivered to network interface module 214.

Method 300 includes an act of sending second client side connection establishment data that would normally be returned by the server (act 303). Act 303 can include the client intermediate side component sending second client side connection establishment data to the client side connection-oriented protocol layer. For example, as illustrated by arrow 3 in FIG. 2, intermediate driver 213 sends data element 262, which includes SYN-ACK 282, to connection-oriented protocol layer 212. Intermediate driver 213 can indicate SYN-ACK 282 by setting the appropriate SYN control bit and the appropriate ACK control bit within data element 261. Intermediate driver 213 can configure data element 262 to appear to have been returned from connection-oriented protocol layer 232. Intermediate driver 213 can update the initial client side sequence number that was received in data element 261 (e.g., by incrementing the initial client side sequence number) and can generate an initial server side sequence number. Intermediate driver 213 can include the updated client side sequence number and the generated initial server side sequence number within data element 262 to simulate a response from connection-oriented protocol layer 232.

Data element 262 may be second client side connection establishment data of a three-way handshake that would normally be returned by connection-oriented protocol layer 232 in response to having received data element 261. Thus, although neither data element 261 nor data element 262 was transferred across network 240, connection-oriented protocol layer 212 may process data element 262 as if data element 262 was received from connection-oriented protocol layer 232. Accordingly, it may appear to connection-oriented protocol layer 212 that a connection (e.g., a TCP connection) from connection-oriented protocol layer 212 to connection-oriented protocol layer 232 has been established.

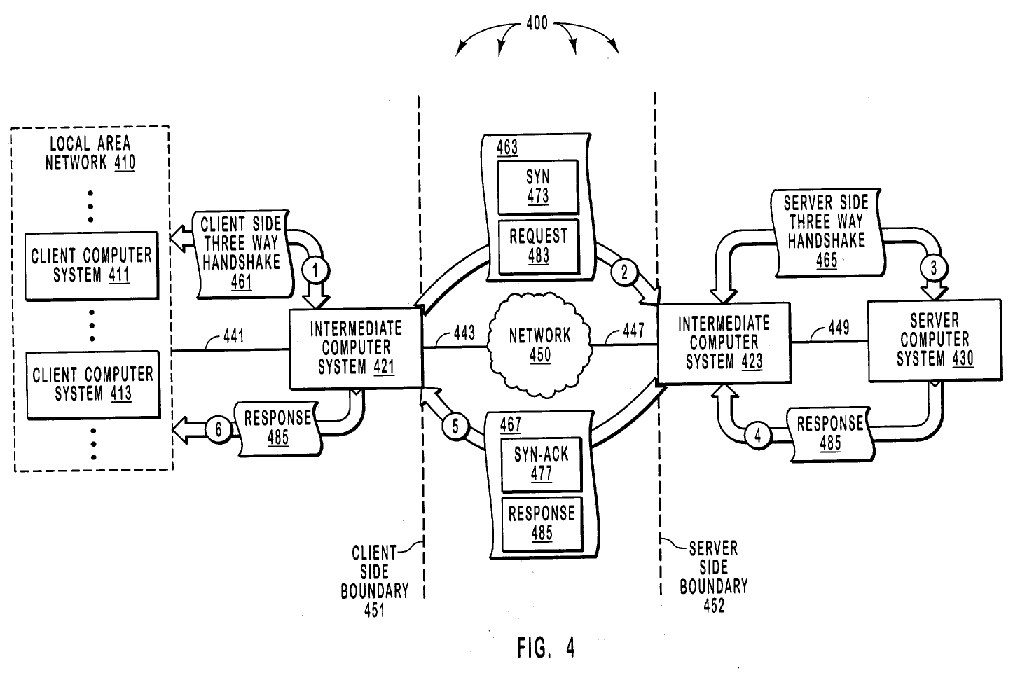

Method 300 includes an act of receiving third client side connection establishment data along with an application layer request (act 304). Act 304 can include the client side intermediate component receiving third client side connection establishment data along with an application layer request from the client side connection-oriented protocol layer. For example, as illustrated by arrow 4 in FIG. 4, intermediate driver 213 receives data element 263, which includes ACK 283 and request 284, from connection-oriented protocol layer 212. Request 284 may have originated from client application 211 as a result of receiving user-input and may have initially caused dispatch of the data element 261 from connection-oriented protocol layer 212. Connection-oriented protocol layer 212 can indicate ACK 283 by setting the appropriate ACK control bit within data element 263. Data element 263 may be third client connection establishment data of a three-way handshake that would normally be returned by connection-oriented protocol layer 212 in response to having received appropriate second connection establishment data from connection-oriented protocol layer 232.

After receiving data element 263, intermediate driver 213 can configure data element 273 to appear as the first data element in a three-way handshake between connection-oriented protocol layer 212 and connection oriented-protocol layer 232. For example, intermediate driver 213 can include SYN 290 in data element 273 by setting the appropriate SYN control bit in data element 273. Likewise, intermediate driver 213 can remove ACK 283 from data element 273 by setting (or unsetting) the appropriate ACK control bit. Further, intermediate driver 213 can include the initial client side sequence number from data element 261 in data element 273. Additionally, intermediate driver 213 can include a network address (e.g., an Internet Protocol (“IP”) address) of server computer system 230 within data element 273. Thus, data element 273 can be configured to include SYN 290, the initial client side sequence number from data element 261, request 284, and a network address of server computer system 230.

In some embodiments, connection-oriented protocol layer 212′ sends ACK 283 and request 284 in separate data elements. For example, connection-oriented protocol layer 212 can send ACK 283 in a first data element and then subsequently send request 284 in a second different data element. Thus, after receiving ACK 283, intermediate driver 213 waits for a specified amount of time (a timeout period) to receive request 284. When request 284 is not received within the specified amount of time, intermediate driver 213 sends a data element (that does not include request 284) to server computer system 230. The data element can include a SYN (by setting the appropriate SYN control bit) and can include the initial client side sequence number from data element 261. Thus, establishment of a connection from client computer system 210 to server computer system 230 can continue even when request 284 is not received. On the other hand, when request 284 is received within the specified amount of time, intermediate driver 213 can configure data element 273 as previously described.

The method 300 includes an act of sending first network connection establishment data along with the application layer request (act 305). Act 305 can include the client side intermediate component sending first network connection establishment data along with the application layer request to a client side network interface module. For example, intermediate driver 213 can send data element 273 to network interface module 214. Network interface module 214 can interpret data within data element 273 (e.g., the network address of server computer system 230) to determine that data element 273 is to be transferred to server computer system 230. Network interface module 214 can subsequently cause data element 273 to be transferred across network 240 to server computer system 230. As illustrated by arrow 5 in FIG. 2, data element 273, which includes SYN 290 and request 284, is transferred from intermediate driver 213, through network interface module 214, to server computer system 230.

Network interface module 234 can receive and interpret data within data element 273. Data element 273 may appear to network interface module 234 to have been sent from connection-oriented protocol layer 212. Accordingly, network interface module 234 can attempt to deliver data element 273 to connection-oriented protocol layer 232.

The method 300 includes an act of receiving first network connection establishment data and the application layer request (act 307). Act 307 can include a server side intermediate component receiving first network establishment data along with the application layer request from the server side network interface module. A server side intermediate component can be situated in a data path between a server side network interface module and a server side connection oriented-protocol layer. As such, data elements being delivered between the server side connection-oriented protocol layer and the server side network interface module can be intercepted by the server side intermediate component. For example, as illustrated by arrow 5 in FIG. 2, intermediate driver 233 receives data element 273, which includes SYN 290 and request 284.

The method 300 includes an act of separating the application layer request (act 308). Act 308 can include the server side intermediate component separating the application layer request from the first network connection establishment data. For example in FIG. 2, intermediate driver 233 can remove request 284 from data element 273.

The method 300 includes an act of sending first network connection establishment data to elicit an acknowledgement (act 309). Act 309 can include the server side intermediate component sending the first network connection establishment data to the server side connection-oriented protocol layer to elicit an acknowledgement from the server side connection-oriented protocol layer. For example, as illustrated by arrow 6 in FIG. 3, intermediate driver 233 transfers data element 274, which includes SYN 290 (but does not include request 284), to connection-oriented-protocol layer 232.

Due to intermediate driver 233's configuration of data element 274, connection-oriented protocol layer 232 may interpret data element 274 as having originated at connection-oriented protocol layer 212. Further, due to the inclusion of the initial client side sequence number from data element 261 (which was received in data element 273), connection-oriented protocol layer 232 may interpret data element 274 as first connection establishment data of a three-way handshake for establishing a connection (e.g., a TCP connection) between connection-oriented protocol layer 212 and connection-oriented protocol layer 232.

Accordingly, connection-oriented protocol layer 232 can respond by sending data element 267, which includes SYN-ACK 287, to acknowledge receipt of SYN 290. Connection-oriented protocol layer 232 can indicate SYN-ACK 287 by setting the appropriate SYN control bit and the appropriate ACK control bit within data element 267. Connection-oriented protocol layer 232 can update the initial client side sequence number that was included within data element 274. Connection-oriented protocol layer 232 can include the updated client side sequence number and an initial server side sequence number identifying the next byte that will be sent by server computer system 230 within data element 267.

The method 300 includes an act of receiving first server side connection establishment data that would normally be returned in response to receiving the first network connection establishment data (act 310). Act 310 can include the server intermediate component receiving first server side connection establishment data from the server side connection-oriented protocol layer. For example, as illustrated by arrow 7 in FIG. 2, intermediate driver 233 receives data element 267, which includes SYN-ACK 287, from connection-oriented-protocol layer 232. Since connection-oriented protocol layer 232 is responding to the receipt of data element 274, which appears to have been sent from connection-oriented protocol layer 212, connection oriented-protocol layer 232 may attempt to cause data element 267 to be delivered to connection-oriented protocol layer 212.

The method 300 includes an act of preventing the first server side connection establishment data from being delivered to the client computer system (act 311). Act 311 can include the server side intermediate component preventing the first server side connection establishment data from being delivered to the client computer system. For example, intermediate driver 233 can prevent data element 267 from being delivered to client computer system 210.

The method 300 includes an act of sending second server side connection establishment data that would normally be returned by the client (act 312). Act 312 can include the server side intermediate component sending second server side connection establishment data along with the application layer request to the server side connection oriented-protocol layer. For example, as illustrated by arrow 8 in FIG. 2, intermediate driver 233 sends data element 268, which includes ACK 288 and request 284, to connection-oriented protocol layer 232. Intermediate driver 233 can indicate ACK 288 by setting the appropriate ACK control bit within data element 268. Intermediate driver 233 can configure data element 268 to appear to have been returned from connection-oriented protocol layer 212. For example, intermediate driver 233 can update the initial server side sequence number that was received in data element 267. Intermediate driver 233 can include the updated server side sequence number within data element 268.

Accordingly, as illustrated by arrow 9 in FIG. 2, connection-oriented protocol layer 232 transfers request 284 to server application 231. In response to receiving request 284, server application 231 can send an application layer response. Server application 231 can configure an application layer response such that the application response is to be delivered to client application 211. Accordingly, connection-oriented protocol layer 232 can receive an application layer response and attempt to deliver the application layer response to network interface module 234.

However, as intermediate driver 233 is in a data path between connection-oriented protocol layer 232 and network interface module 234, intermediate driver 233 may receive the application layer response. The method 300 includes an act of receiving an application layer response corresponding to the application layer request (act 313). Act 313 can include the server side intermediate component receiving an application layer response from the server side application layer. For example, as illustrated by arrow 10 in FIG. 2, intermediate driver 233 receives response 289 (e.g., a response portion of an idempotent transaction).

The method 300 includes an act of sending second network connection establishment data along with the application layer response (act 314). Act 314 can include the server side intermediate component sending second network connection establishment data along with the application layer response to the server side network interface module. The server side intermediate component can configure the second network connection establishment data such that the server network interface module transfers the second network connection establishment data and the application layer response to the client computer system.

Intermediate driver 233 can configure data element 271 to appear as the second data element in a three-way handshake between connection-oriented protocol layer 212 and connection oriented-protocol layer 232. For example, intermediate driver 233 can include SYN-ACK 291 in data element 271 by setting the appropriate SYN control bit and the appropriate ACK control bit in data element 271. Further, intermediate driver 233 can include the updated client side sequence number and the initial server side sequence number from data element 267. Additionally, intermediate driver 233 can include a network address of client computer system 210 within data element 271. Thus, data element 271 can be configured to include SYN-ACK 291, the updated client side sequence number from data element 267, the initial server side sequence number from data element 267, response 289, and a network address of client computer system 210.

In some embodiments, intermediate driver 233 does not receive response 289 within a specified amount of time. In these embodiments, intermediate driver 233 does not configure data element 271 to include response 289. However, data element 271 is otherwise configured in a manner as previously described. Thus, establishment of a connection from server computer system 230 to client computer system 210 can continue even when response 289 is not received.

Network interface module 234 can interpret data within data element 271 (e.g., the network address of client computer system 210) to determine that data element 271 is to be transferred to client computer system 210. Network interface module 234 can subsequently cause data element 271 to be transferred across network 240 to client computer system 210. As illustrated by arrow 11 in FIG. 2, data element 271, which includes SYN-ACK 291 and response 284, is transferred from intermediate driver 233, through network interface module 234, to client computer system 210.

Network interface module 214 can receive and interpret data form within data element 271. Data element 271 may appear to network interface module 214 to have been sent from connection-oriented protocol layer 232. Accordingly, network interface module 214 can attempt to deliver data element 271 to connection-oriented protocol layer 212. However, as intermediate driver 213 is in a data path between connection-oriented protocol layer 212 and network interface module 214, intermediate driver 213 may receive data element 271.

The method 300 includes an act of receiving second network connection establishment data and the application layer response (act 306). Act 306 can include the client side intermediate component receiving second network connection establishment data along with an application layer response originating from the server side application layer. For example, as illustrated by arrow 11 in FIG. 2, intermediate driver 213 receives data element 271, which includes SYN-ACK 291 and response 289. As illustrated by arrow 12 in FIG. 2, intermediate component 213 can subsequently cause response 289 to be delivered to client application 211.

FIG. 4 illustrates a second example of network architecture 400 that can facilitate performing an application layer transaction during the connection establishment phase of a connection-oriented protocol. Included in network architecture 400 are local area network 410, intermediate computer system 421, network 450, intermediate computer system 423, and server computer system 430. It may be that local area network 410 has improved transmission characteristics when compared to network 450. For example, local area network 410 may have less latency and/or may have greater bandwidth capacity than network 450. In some embodiments, local area network 410 is an Ethernet segment and network 450 is the Internet.

Logical communication link 441 connects intermediate computer system 421 to local area network 410. Logical communication link 441 can also have improved transmission characteristics relative to network 450 and can even be included on the same Ethernet segment with client computer systems 411 and 413. Logical communication link 449 connects intermediate computer system 423 to server computer system 430. Similar to logical communication link 441, logical communication link 449 can have improved transmission characteristics relative to network 450 and may also be an Ethernet segment. Logical communication links 443 and 447 connect intermediate computer system 421 and intermediate computer system 423 to network 450 respectively.

A client computer system included in local area network 410, such as, for example, client computer system 411, may generate an application layer request that is to be delivered to server computer system 430. Accordingly, client computer system 411 can attempt to establish a connection to server computer system 430 to deliver the application layer request. To initiate establishment of a connection, a connection-oriented protocol layer at client computer system 411 may send a SYN data element that is to be delivered to a corresponding connection-oriented protocol layer at server computer system 430. Intermediate computer system 421 receives the SYN data element and prevents the SYN data element from being delivered to server computer system 430.

Intermediate computer system 421 responds, by sending a SYN-ACK data element to client computer system 411. Intermediate computer system 421 can appropriately update an initial client side sequence number. Intermediate computer system 421 can appropriately include the updated client side sequence number and an initial server side sequence number within the SYN-ACK data element to simulate the operations that server computer system 430 would have performed. Accordingly, client computer system can respond to the SYN-ACK data element by sending an ACK data element, which C includes request 483, to intermediate computer system 421. Thus, as illustrated by arrow 1 in FIG. 4, a client side three-way handshake 461 is performed via local area network 410 and logical communication link 441. As such, it may appear to client computer system 411 that a connection from client computer system 411 to server computer system 430 has been established.

As illustrated by arrow 2 in FIG. 4, intermediate computer system 421 sends data element 463, which includes SYN 473 and request 483, to intermediate computer system 423. Intermediate computer system 423 receives data element 463. Intermediate computer system 423 separates request 483 from SYN 273 and forwards SYN 273 (and an appropriate initial client side sequence number) to server computer system 430. Accordingly, server computer system 430 responds to SYN 273 by sending a SYN-ACK data element including an appropriately updated client side sequence number and an appropriate initial server side sequence number.

Intermediate computer system 423 receives the SYN-ACK data element. Intermediate computer system 423 responds to the SYN-ACK data element with an ACK data element including an appropriately updated server side sequence number and the application layer request. Thus, as illustrated by arrow 3 in FIG. 4, a server side three-way handshake 465 is performed via logical communication link 449. As such, it may appear to server computer system 430 that a connection from server computer system 430 to client computer system 411 has been established.

As illustrated by arrow 4 in FIG. 4, server computer system 430 can respond by sending response 485 to intermediate computer system 423. After receiving response 485, intermediate computer system 423 can configure data element 467 to include SYN-ACK 477 and response 485. As illustrated by arrow 5 in FIG. 4, intermediate computer system 423 sends data element 467 to intermediate computer system 421. Intermediate computer system 421 receives data element 467. As illustrated by arrow 6 in FIG. 4, intermediate computer system 421 then sends data element 467 to client computer system 411.

It should be understood that the principles of the present invention do not inhibit the performance of a conventional network three-way handshake for establishing a connection between a client computer system and a server computer system. In some network environments, it may be the case that a client computer system includes a client side intermediate component (e.g., intermediate driver 213) but a server computer system does not include a server side intermediate component. In these environments, a server side connection-oriented protocol layer (e.g., connection-oriented protocol layer 232) can respond to network connection establishment data (e.g., SYN 290) included in a network data element (e.g., data element 273) while ignoring other data (e.g., request 284) included in the network data element. The client side intermediate component can configure network data elements for appropriately completing a network three-way handshake sequence (e.g., setting control bits and updating sequence numbers) across a network (e.g., network 240). Thus, it may appear to the server side connection-oriented protocol layer that a client side connection-oriented protocol layer (e.g., connection-oriented protocol layer 212) is responding. Alternately, the client side intermediate component can ignore network data elements of a network three-way handshake and let the network data elements pass to the client side connection-oriented protocol layer unaltered.

Thus, the principles of the present provide for completing an application layer transaction without having to wait for a connection to be established between a client and a server. The application layer transaction can be completed with increased efficiency since the number of round-trips over a network utilized to complete the application layer transaction is potentially reduced. Further, components of the present invention can operate in a manner that is transparent to computer systems that lack functionality to perform application layer transactions during a connection establishment phase.

Embodiments of the present invention can be particularly advantageous when an application layer request and/or application layer response of an idempotent transaction is included along with connection establishment data. During connection establishment, retransmissions can occur causing the same application layer request and/or application layer response to be piggybacked over connection establishment data packets multiple times. However, since the effects of an idempotent transaction do not change even if the idempotent transaction is executed multiple times, retransmissions have little, if any, negative impact on a server.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

What is claimed and desired secured by United States Letters Patent is:

1. In a computer network that includes a client computer system that implements a client side data path that extends from a client side application layer, through a client side connection-oriented protocol layer, through a client side intermediate component, and to a client side network interface module, the computer network also including a server computer system that implements a server side data path that extends from a server side application layer, through a server side connection-oriented protocol layer, through a server side intermediate component, and to a server side network interface module, a method for the client computer system to initiate an application layer transaction during the connection establishment phase of a connection-oriented protocol rather than awaiting the completion of the connection establishment phase to thereby reduce the time needed to complete the application layer transaction, the method comprising the following:
an act of the client side intermediate component receiving first client side connection establishment data from the client side connection-oriented protocol layer, the first client side connection establishment data being sufficient to elicit an acknowledgment from the server side connection-oriented protocol layer if received by the server side connection-oriented protocol layer;
an act of the client side intermediate component preventing the first client side connection establishment data from being delivered to the server computer system;
an act of the client side intermediate component sending second client side connection establishment data to the client side connection-oriented protocol layer, the second client side connection establishment data being data that would normally be returned by the server side connection-oriented protocol layer in response to having received the first client side connection establishment data;
an act of the client side intermediate component receiving third client side connection establishment data along with an application layer request from the client side connection-oriented protocol layer, the application layer request originating from the client side application layer and originally causing the dispatch of the first client side connection establishment data from the client side connection-oriented protocol layer to the client side intermediate component, the third client side connection establishment data being data that would normally be returned by the client side connection-oriented protocol layer in response to having received the second client side connection establishment data from the server computer system;
an act of the client side intermediate component sending first network connection establishment data along with the application layer request to the client side network interface module, the first network connection establishment data being sufficient to elicit an acknowledgment message from the server side connection-oriented protocol layer; and
an act of the client side intermediate component receiving second network connection establishment data along with an application layer response originating from the server side application layer, the second network connection establishment data representing an acknowledgement from the server side intermediate component that was generated in response to having received the first network connection establishment data, the application layer response representing a response to the application layer request.

2. The method as recited in claim 1, wherein the act of the client side intermediate component receiving first client side connection establishment data from the client side connection-oriented protocol layer comprises an act of the client side intermediate component receiving an SYN packet from a TCP layer.

3. The method as recited in claim 1, wherein the act of the client side intermediate component preventing the first client side connection establishment data from being delivered to the server computer system comprises an act of preventing a SYN packet from being delivered to a Web server.

4. The method as recited in claim 1, wherein the act of client side intermediate component sending second client side connection establishment data to the client side connection-oriented protocol layer comprises an act of sending a SYN-ACK packet to a TCP layer.

5. The method as recited claim 1, wherein the act of the client side intermediate component receiving third client side connection establishment data along with an application layer request from the client side connection-oriented protocol layer comprises an act of receiving an ACK packet along with a request portion of an idempotent transaction.

6. The method as recited in claim 5, wherein the act of receiving an ACK packet along with a request portion of an idempotent transaction comprises an act of receiving an ACK packet along with an HTTP GET command.

7. The method as recited in claim 5, wherein the act of receiving an ACK packet along with a request portion of an idempotent transaction comprises an act of receiving an ACK packet along with an HTTP HEAD command.

8. The method as recited claim 1, wherein the act of the client side intermediate component receiving third client side connection establishment data along with an application layer request from the client side connection-oriented protocol layer comprises an act of receiving a data packet that includes both the third client side connection establishment data along and the application layer request.

9. The method as recited claim 1, wherein the act of the client side intermediate component receiving third client side connection establishment data along with an application layer request from the client side connection-oriented protocol layer comprises:
an act of receiving a connection establishment data packet including the third client side connection establishment data; and
an act of receiving a request data packet including the application layer request.

10. The method as recited claim 1, wherein the act of the client side intermediate component sending first network connection establishment data along with the application layer request to the client side network interface module comprises an act of sending a data C packet that includes a SYN and an HTTP GET command.

11. The method as recited claim 1, wherein the act of the client side intermediate component receiving second network connection establishment data along with an application layer response originating from the server side application layer comprises an act of receiving a SYN-ACK packet along with a at least a portion of a Web page.

12. The method as recited in claim 1, further comprising:
an act of the client side intermediate component sending the application layer response to the client side connection-oriented protocol layer.

13. The method as recited in claim 12, wherein the act of the client side intermediate component sending the application layer response to the client side connection-oriented protocol layer comprises an act of sending at least a portion of a Web page after stripping a SYN-ACK from a data packet including the at least a portion of a Web page.

14. In a computer network that includes a server computer system that implements a server side data path that extends from a server side application layer, through a server side connection-oriented protocol layer, through a server side intermediate component, and to a server side network interface module, the computer network also including a client computer system that implements a client side data path that extends from a client side application layer, through a side client connection-oriented protocol layer, through a client side intermediate component, and to a client side network interface module, a method for the server computer system to participate in an application layer transaction during the connection establishment phase of a connection-oriented protocol rather than awaiting the completion of the connection establishment phase to thereby reduce the time needed to complete the application layer transaction, the method comprising the following:
an act of the server side intermediate component receiving first network connection establishment data along with an application layer request from the server side network interface module, the first network connection establishment data being sufficient to elicit an acknowledgment message from the server side connection-oriented protocol layer, the application layer request originating from the client side application layer and originally causing the dispatch of the first network connection establishment data from the client computer system to the server side network interface module;
an act of the server side intermediate component separating the application layer request from the first network connection establishment data;
an act of the server side intermediate component sending the first network connection establishment data to the server side connection-oriented protocol layer to elicit an acknowledgement from the server side connection-oriented protocol layer;
an act of the server side intermediate component receiving first server side connection establishment data from the server side connection-oriented protocol layer, the first server side connection establishment data being data that would normally be returned by the server side connection-oriented protocol layer in response to having received the first network connection establishment data;
an act of the server side intermediate component preventing the first server side connection establishment data from being delivered to the client computer system;
an act of the server side intermediate component sending second server side connection establishment data along with the application layer request to the server side connection-oriented protocol layer, the second server side connection establishment data being data that would normally be returned by the client side connection-oriented protocol layer in response to having received the first server side connection establishment data;
an act of the server side intermediate component receiving an application layer response from the server side application layer, the application layer response representing a response to the application layer request; and
an act of the server side intermediate component sending second network connection establishment data along with the application layer response to the server side network interface module, the second network connection establishment data representing an acknowledgement from the server side intermediate component that was generated in response to having received the first network connection establishment data.

15. The method as recited in claim 14, wherein the act of the server side intermediate component receiving first network connection establishment data along with an application layer request from the server side network interface module comprises an act of receiving a SYN packet along with an HTTP GET command.

16. The method as recited in claim 14, wherein the act of the server side intermediate component separating the application layer request from the first network connection establishment data comprises an act of separating an HTTP GET from a SYN packet.

17. The method as recited in claim 14, wherein the act of the server side intermediate component sending the first network connection establishment data to the server side connection-oriented protocol layer comprises an act of sending a SYN packet to a TCP layer.

18. The method as recited in claim 14, wherein the act of the server side intermediate component receiving first server connection establishment data from the server side connection-oriented protocol layer comprises an act of receiving a SYN-ACK packet from a TCP layer.

19. The method as recited in claim 14, wherein the act of the server side intermediate component preventing the first server side connection establishment data from being delivered to the client computer system comprises an act of preventing a SYN-ACK packet from being delivered.

20. The method as recited in claim 14, wherein the act the server side intermediate component sending second server side connection establishment data along with the application layer request to the server side connection-oriented protocol layer comprises an act of sending an ACK packet along with an HTTP GET command.

21. The method as recited in claim 14, wherein the act of the server side intermediate component receiving an application layer response from the server side application layer comprises an act of receiving at least a portion of a Web page from a Web server.

22. The method as recited in claim 14, wherein the act of the server side intermediate component sending second network connection establishment data along with the application layer response to the server side network interface module comprises act of sending a SYN-ACK packet along with at least a portion of a Web page.

23. In a client side intermediate computer system that is network connectable to the Internet and a local area network including one or more client computer systems, a method for the client side intermediate computer system to participate in an HTTP transaction during a TCP connection establishment phase rather than awaiting the completion of the TCP connection establishment phase to thereby reduce the time needed to complete the HTTP transaction, the method comprising the following:
an act of receiving a client side SYN packet from a client computer system, the SYN packet being sufficient to elicit an acknowledgment from a server computer system if received by the server computer system;
an act of preventing the client side SYN packet from being delivered to the Internet;
an act of sending a client side SYN-ACK packet to the client computer system, the client side SYN-ACK packet being a SYN-ACK packet that would normally be returned by the server computer system in response to having received the client side SYN packet;
an act of receiving a client side ACK packet along with an HTTP request from the client computer system, the client side ACK packet being an ACK packet that would normally be returned by the client computer system in response to receiving the client side SYN-ACK packet;
an act of sending a network SYN packet along with the HTTP request to the server computer system, the network SYN packet being sufficient to elicit an acknowledgment message from the server computer system;
an act of receiving a network SYN-ACK packet along with at least a portion of a Web page from the server computer system, the SYN-ACK packet representing an acknowledgement of the network SYN packet, the at least a portion of a Web page representing a response to the HTTP request.

24. The method as recited in claim 23, further comprising:
an act of sending the at least a portion of a Web page to the client computer system.

25. In a server side intermediate computer system that is network connectable to the Internet and a server computer system, a method for the server side intermediate computer system to participate in an HTTP transaction during a TCP connection establishment phase rather than awaiting the completion of the TCP connection establishment phase to thereby reduce the time needed to complete the HTTP transaction, the method comprising the following:
an act of receiving a network SYN packet along with an HTTP request, the HTTP request originating at a client computer system;
an act of sending the network SYN packet to the server computer system;
an act of receiving a server side SYN-ACK packet, the server side SYN-ACK packet being a SYN-ACK packet that would normally be returned by the server computer system in response to having received the network SYN packet;
an act of preventing the server side SYN-ACK packet from being delivered to the Internet;
an act of sending a server side ACK packet along with the HTTP request to the server computer system, the server side ACK packet being an ACK packet that would normally be returned by the client computer system in response to having received server side SYN-ACK packet;
an act of receiving at least a portion of a Web page from the server computer system, the at least a portion of a Web page representing a response to the HTTP request; and
an act of sending a network SYN-ACK packet along with the at least a portion of a Web page to the client computer system, the network SYN-ACK packet representing an acknowledgement that was generated in response to having received the network SYN packet.

26. A computer program product for use in a computer network that includes a client computer system that implements a client side data path that extends from a client side application layer, through a client side connection-oriented protocol layer, through a client side intermediate component, and to a client side network interface module, the computer network also including a server computer system that implements a server side data path that extends from a server side application layer, through a server side connection-oriented protocol layer, through a server side intermediate component, and to a server side network interface module, the computer program product for implementing a method for the client computer system to initiate an application layer transaction during the connection establishment phase of a connection-oriented protocol rather than awaiting the completion of the connection establishment phase to thereby reduce the time needed to complete the application layer transaction, the computer program product comprising one or more computer-readable media having stored thereon the following:
computer-executable instructions for causing the client side intermediate component to receive first client side connection establishment data from the client side connection-oriented protocol layer, the first client side connection establishment data being sufficient to elicit an acknowledgment from the server side connection-oriented protocol layer if received by the server side connection-oriented protocol layer;
computer-executable instructions for causing the client side intermediate component to prevent the first client side connection establishment data from being delivered to the server computer system;
computer-executable instructions for causing the client side intermediate component to send second client side connection establishment data to the client side connection-oriented protocol layer, the second client side connection establishment data being data that would normally be returned by the server side connection-oriented protocol layer in response to having received the first client side connection establishment data;
computer-executable instructions for causing the client side intermediate component to receive third client side connection establishment data along with an application layer request from the client side connection-oriented protocol layer, the application layer request originating from the client side application layer and originally causing the dispatch of the first client side connection establishment data from the client side connection-oriented protocol layer to the server computer system t, the third client side connection establishment data being data that would normally be returned by the client side connection-oriented protocol layer in response to having received the second client side connection establish data from the server computer system;
computer-executable instructions for causing the client side intermediate component to send first network connection establishment data along with the application layer request to the client side network interface module, the first network connection establishment data being sufficient to elicit an acknowledgment message from the server side connection-oriented protocol layer; and
computer-executable instructions for causing the client side intermediate component to receive second network connection establishment data along with an application layer response originating from the server side application layer, the second network connection establishment data representing an acknowledgement from the server side intermediate component that was generated in response to having received the first network connection establishment data, the application layer response representing a response to the application layer request.

27. A computer program product for use in a computer network that includes a server computer system that implements a server side data path that extends from a server side application layer, through a server side connection-oriented protocol layer, through a server side intermediate component, and to a server side network interface module, the computer network also including a client computer system that implements a client side data path that extends from a client side application layer, through a client side connection-oriented protocol layer, through a client side intermediate component, and to a client side network interface module, the computer program product for implementing a method for the server computer system to participate in an application layer transaction during the connection establishment phase of a connection-oriented protocol rather than awaiting the completion of the connection establishment phase to thereby reduce the time needed to complete the application layer transaction, the computer program product comprising one or more computer-readable media have stored thereon the following:
computer-executable instructions for causing the server side intermediate component to receive first network connection establishment data along with an application layer request from the server side network interface module, the first network connection establishment data being sufficient to elicit an acknowledgment message from the server side connection-oriented protocol layer, the application layer request originating from the client side application layer and causing the dispatch of the first network connection establishment data from the client computer system to the server side network interface module;
computer-executable instructions for causing the server side intermediate component to separate the application layer request from the first network connection establishment data;
computer-executable instructions for causing the server side intermediate component to send the first network connection establishment data to the server side connection-oriented protocol layer to elicit an acknowledgement from the server side connection-oriented protocol layer;
computer-executable instructions for causing the server side intermediate component to receive first server side connection establishment data from the server side connection-oriented protocol layer, the first server side connection establishment data being data that would normally be returned by the server side connection-oriented protocol layer in response to having received the first network connection establishment data;
computer-executable instructions for causing the server side intermediate component to prevent the first server side connection establishment data from being delivered to the client computer system;
computer-executable instructions for causing the server side intermediate component to send second server side connection establishment data along with the application layer request to the server side connection-oriented protocol layer, the second server side connection establishment data being data that would normally be returned by the client side connection-oriented protocol layer in response to having received the first server side connection establishment data;
computer-executable instructions for causing the server side intermediate component to receive an application layer response from the server side application layer, the application layer response representing a response to the application layer request; and
computer-executable instructions for causing the server side intermediate component to send second network connection establishment data along with the application layer response to the server side network interface module, the second network connection establishment data representing an acknowledgement from the server side intermediate component that would have been generated in response to having received the first network connection establishment data.

28. A computer system configured to participate in an application layer transaction during the connection establishment phase of a connection-oriented protocol, comprising:
one or more processing units; and
one or more computer readable media having stored thereon a client side intermediate component, the client side intermediate component being configured to:
receive first client side connection establishment data from a client side connection-oriented protocol layer, the first client side connection establishment data being sufficient to elicit an acknowledgment from a server system if received by the server system;
prevent the first client side connection establishment data from being delivered to the server computer system;
send second client side connection establishment data to the client side connection-oriented protocol layer, the second client side connection establishment data being data that would normally be returned by the server computer system in response to having received the first client side connection establishment data;
receive third client side connection establishment data along with an application layer request from the client side connection-oriented protocol layer, the application layer request originating from a client side application layer and originally causing the dispatch of the first client side connection establishment data from the client side connection-oriented protocol layer, the third client side connection establishment data being data that would normally be returned by the client side connection-oriented protocol layer in response to having received the second client side connection establish data from the server computer system;
send first network connection establishment data along with the application layer request to the server computer system, the first network connection establishment data being sufficient to elicit an acknowledgment message from the server computer system; and
receive second network connection establishment data along with an application layer response originating from the server computer system, the second network connection establishment data representing an acknowledgement from the server computer system that was generated in response to having received the first network connection establishment data, the application layer response representing a response to the application layer request.

29. A computer system configured to participate in an application layer transaction during the connection establishment phase of a connection-oriented protocol, comprising:
one or more processing units; and
one or more computer readable media having stored thereon a server side intermediate component, the server side intermediate component being configured to:
receive first network connection establishment data along with an application layer request from a client computer system, the first network connection establishment data being sufficient to elicit an acknowledgment message from a server side connection-oriented protocol layer;
separate the application layer request from the first network connection establishment data;
send the first network connection establishment data to the server side connection-oriented protocol layer to elicit an acknowledgement from the server side connection-oriented protocol layer;
receive first server side connection establishment data from the server side connection-oriented protocol layer, the first server side connection establishment data being data that would normally be returned by the server side connection-oriented protocol layer in response to having received the first network connection establishment data;
prevent the first server side connection establishment data from being delivered to the client computer system;
send second server side connection establishment data along with the application layer request to the server side connection-oriented protocol layer, the second server side connection establishment data being data that would normally be returned by the client computer system in response to having received the first server side connection establishment data;
receive an application layer response from a server side application layer, the application layer response representing a response to the application layer request; and
send second network connection establishment data along with the application layer response to the client computer system, the second network connection establishment data representing an acknowledgement of the first network connection establishment data that was generated in response to having received the first network connection establishment data.
